(19) United States
(12) Patent Application Publication
(10) Pub. No.: US 2010/0102967 A1
(43) Pub. Date: Apr. 29, 2010

(54) CONTAINER LID WITH A RFID TAG

(76) Inventors: Sang Mok Lee, Suyeong-gu (KR); Hee Sook Lee, Geumjeong-gu (KR); Woo Seong Kim, Haeundae-gu (KR); Dae Hyun Cho, Yangcheon-gu (KR); Sun Hee Lee, Gangnam-gu (KR); Sang Yeul Lee, Bucheon-si (KR)

Correspondence Address: MERCHANT & GOULD PC, P.O. BOX 2903, MINNEAPOLIS, MN, 55402-0903, US

(21) Appl. No.: 12/331,027

(22) Filed: Dec. 9, 2008

(30) Foreign Application Priority Data
Oct. 27, 2008 (KR) 10-2008-0105094

(51) Int. Cl. G08B 13/14

(52) U.S. Cl. 340/572.8

(57) ABSTRACT

The present invention provides a container lid with a removable built-in RFID tag which makes it easy to perform general management, such as information management, inventory management, use list management, hazardous material management, etc., of contents stored in the container. The container lid with the RFID tag according to the present invention includes a main body which covers an open end of a container, and a tag mount which protrudes from the upper surface of the main body. The tag mount is open on the upper end thereof and has therein an installation space, into which the RFID tag is inserted through the open upper end of the tag mount. The container lid further includes a tag holder which holds and supports the RFID tag in the tag mount, and a tag mount cover which covers the open upper end of the tag mount.

This application claims benefit of Serial No. 10-2008-0105094, filed 27 Oct. 2008 in Korea and which application is incorporated herein by reference. To the extent appropriate, a claim of priority is made to the above disclosed application.

### BACKGROUND OF THE INVENTION

1. Field of the Invention

The present invention relates generally to container lids with RFID (radio frequency identification) tags and, more particularly, to a container lid with a removable built-in RFID tag which makes it easy to perform general management, such as information management, inventory management, usage list management, hazardous material management, etc., of contents stored in the container.

2. Description of the Related Art

Generally, solid, liquid or gas, in addition to material in a gel or sol state, is stored in a container made of plastic, glass or the like. To prevent contents contained in the container from evaporating or becoming contaminated by moisture or impurities, the open upper end of the container is covered with a container lid. Typically, the container lid is threaded over the circumferential outer surface of the open upper end of the container and is opened or closed by rotating it.

The contents, for example chemicals, chemical reagents, cosmetics, alcoholic liquors, beverages, etc., contained in containers are of various kinds and have various purposes. Furthermore, depending on the kinds and purposes of contents contained in the containers, unique characteristics such as the ingredients, properties, effects, date of manufacture, degree of hazardousness, etc., of the contents differ. Therefore, during distribution or storage of the contents, there have been difficulties in performing history management, inventory management or hazardous material management of the contents. As a representative example of a means for overcoming difficulties in the content management, a barcode recognition technology which is a contact type information recognition technology was developed and has been used. Recently, an RFID technique which is a non-contact type of information recognition technology using radio frequency recognition was developed and has been commercialized in various fields.

With regard to the RFID technology, an RFID tag which includes peculiar information of an object to distinguish the object from other substances is attached to the object. An RFID device (typically, including a reader and a writer) can recognize the radio frequency of the RFID tag, collect the peculiar information about corresponding contents from the RFID tag, and process the collected information. Hence, the RFID technology is very useful for history management, inventory management or hazardous material management in various fields.

However, in the case where liquid contents, such as chemicals, chemical reagents, liquid cosmetics, alcoholic liquors, beverages, etc., are stored in a container, if an RFID tag is attached to the outer surface of the container, correct recognition of the frequency used for RFID is markedly reduced due to the properties of the liquid medium, with the result that information recognition and data processing cannot be correctly performed. In an effort to overcome the above problem, as shown in FIG. 1, an RFID tag T has been used in such a way that it is attached to the upper surface of a lid 20 of a container 10 using adhesive or an adhesive cover. However, in the case where the RFID tag T is attached to the surface of the lid 20 using adhesive or the like, the RFID tag T may malfunction or be damaged by moisture contained in air or abrupt external impact. In addition, there is a probability of loss of the RFID tag T because it may unfortunately get separated from the lid 20.

In order to solve the above-mentioned problems of the RFID tag attached to the surface of the container lid, a technique in which an RFID tag is installed in a container lid by insert molding was proposed in Korean Patent Registration No. 10-0615387 (hereinafter, referred to simply as ‘registered patent’). FIG. 2 is a sectional view illustrating the structure of a container lid according to the registered patent. As shown in the drawing, an installation space 22 having a predetermined depth is formed in a portion of the upper surface of the container lid 20. Furthermore, an insulation member 24 for blocking electromagnetic waves is provided on the inner surface of the installation space 22. An RFID tag T is disposed in the insulation member 24. The RFID tag T includes a control unit, a memory unit and a radio transceiver having an antenna and a power generator. The opening of the installation space 22 in which the RFID tag T is installed is covered with an adhesive cover 26. A waterproof agent 28 is applied to the upper surface of the adhesive cover 26.

In the case of the container lid according to the registered patent, albeit having a high RF recognition rate compared to that of the prior technique in which the RFID tag is attached to the surface of the container lid, there is a disadvantage in that it is impossible to replace the RFID tag T with a new one, because the RFID tag T is adhered to the surface of the insulation member 24 by adhesive or the like and is adhered to and covered with the adhesive cover 26 and the waterproof agent 28 is applied to the outer surface of the adhesive cover 26.

RFID technology rapidly develops every year, and international standardization methods have been continuously discussed and varied. Furthermore, defects of RFID tags are relatively high and reach about 5% of production, and the expected lifetime thereof is about a relatively short two years. Thus, in the case of variation in the international standardization technology or defectiveness or damage of the RFID tag, or in the case where there is renewal of content information, the RFID tag must be able to be rapidly replaced with a new one in order to maintain the continuity of content management. Particularly, if contents stored in the container are chemicals, organic vapor or moisture may easily cause a problem, such as erosion which is fatal to RFID tags and shortens their lifespan. Because the contents stored in the container mainly are materials with viable periods ranging from several days to several decades, replacement of the RFID tag is indispensable.

However, in the case of the container lid according to the registered patent, the RFID tag is fixed, in other words, it is very difficult to replace it with a new one. Hence, if it is required to replace the RFID tag with a new one, the entire container lid must be replaced with a new one, thus causing consumption of resources. Even if the container lid is disassembled to replace the RFID tag with a new one, a reassembly process including installation of the insulation member, adhesion of the new RFID tag, attachment of the adhesive cover and application of the waterproof agent is very complex and requires a lot of time. This process is very inefficient. Therefore, a container lid, which is capable of easily replacing an RFID tag with a new one when necessary is required.

### SUMMARY OF THE INVENTION

Accordingly, the present invention has been made keeping in mind the above problems occurring in the prior art, and an object of the present invention is to provide a container lid which is constructed such that an RFID tag can be easily installed in a main body of the lid, can be prevented from malfunctioning or being damaged by external factors, and can be easily replaced with a new one when necessary, thus ensuring the continuity of content management.

The above and other objects, features and advantages of the present invention will be more clearly understood from the following detailed description of embodiments with reference to the accompany drawings. Furthermore, the objects, features and advantages of the present invention can be implemented by the appended claims or combination thereof.

In order to accomplish the above object, the present invention provides a container lid with an RFID (radio frequency identification) tag, including: a main body to cover an open end of a container; a tag mount protruding from an upper surface of the main body, the tag mount being open on an upper end thereof and having therein an installation space into which the RFID tag is inserted through the open upper end of the tag mount; a tag holder to hold and support the RFID tag in the tag mount; and a tag mount cover to cover the open upper end of the tag mount.

Preferably, the RFID tag may comprise a plastic card type tag, having: an IC chip to store various kinds of information about contents contained in the container; and an antenna for performing radio communication. The plastic card type tag may be covered and sealed with synthetic resin.

The tag mount may comprise a frame protruding from the upper surface of the main body such that the installation space is defined in the frame, with a locking extension extending inwards from an upper end of the frame such that a holder mounting recess is formed by the locking extension along a lower portion of an inner sidewall of the frame, so that the tag holder is inserted into the holder mounting recess.

The tag holder may have a ring shape which is open on one portion thereof to form an opening, wherein an inner surface of the tag holder has a shape corresponding to a shape of a periphery of the RFID tag so as to hold an outer surface of the RFID tag, and opposite ends of the open portion of the tag holder are bent inwards to prevent the RFID tag from being removed from the tag holder through the open portion of the tag holder.

The tag holder may be made of soft elastic synthetic resin. The tag mount cover may be made of transparent material.

Furthermore, the tag mount cover may be made of a transparent film, and a perimeter of the tag mount cover may be adhered to an upper surface of the tag mount by heat welding, thus sealing the open upper end of the tag mount.

### BRIEF DESCRIPTION OF THE DRAWINGS

FIG. 1 is a view showing a typical RFID tag attached to a container lid;

FIG. 2 is a sectional view of a container lid with a built-in RFID tag according to a conventional technique;

FIG. 3 is a perspective view of a container lid with a removable built-in RFID tag, according to an embodiment of the present invention;

FIG. 4 is an exploded perspective view of the container lid with the removable built-in RFID tag of FIG. 3;

FIG. 5 is a sectional view of the container lid with the removable built-in RFID tag of FIG. 3; and

FIG. 6 is a sectional view of a container lid with a removable built-in RFID tag, according to another embodiment of the present invention.

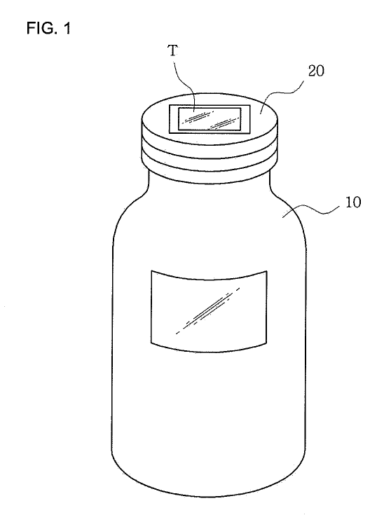

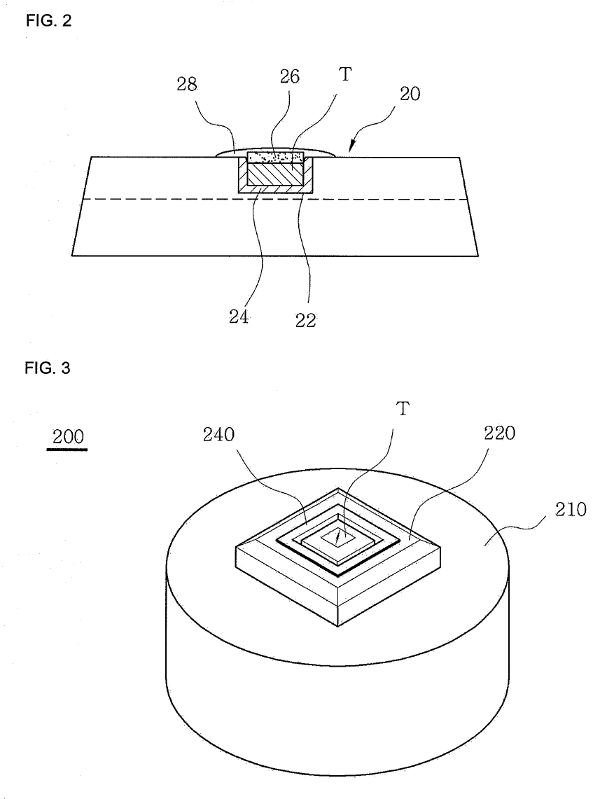

### DESCRIPTION OF THE PREFERRED EMBODIMENTS

Hereinafter, a container lid with a removable built-in RFID tag according to the present invention will be described in detail with reference to the attached drawings and preferred embodiments.

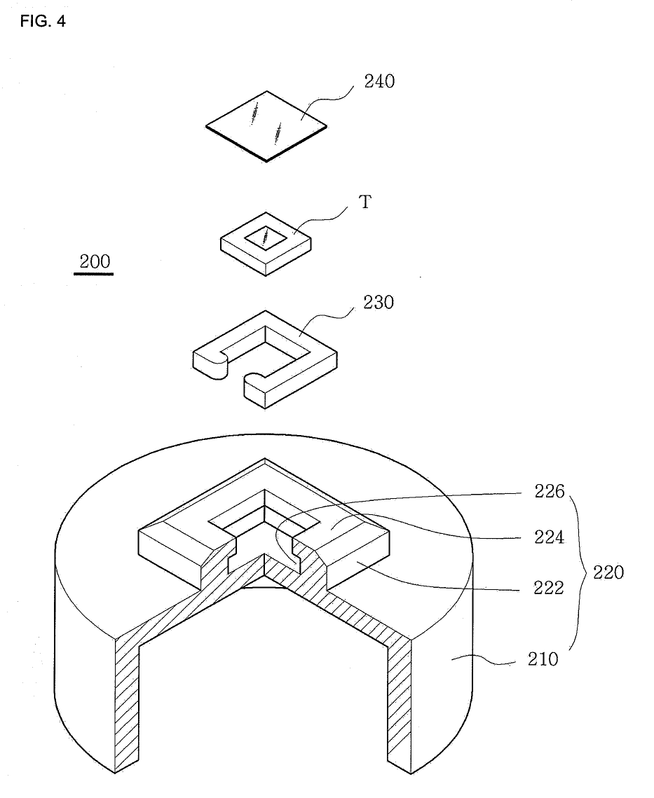

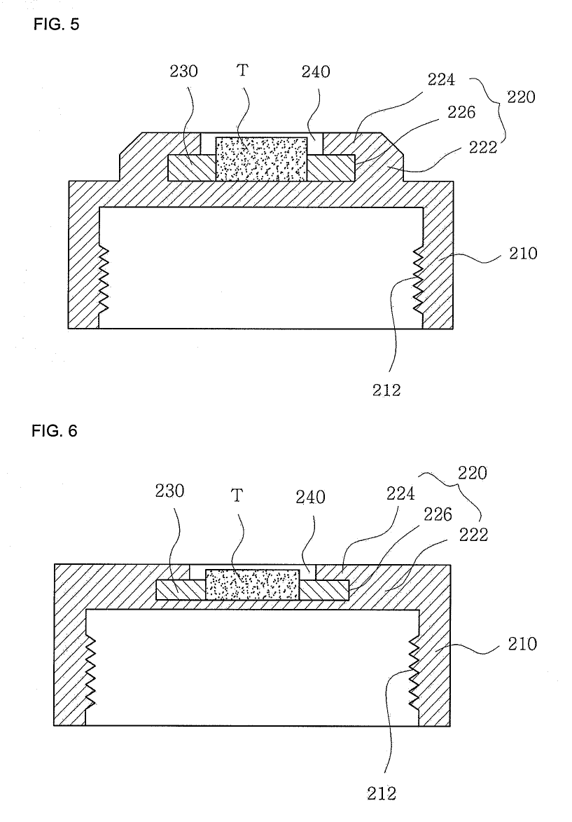

FIG. 3 is a perspective view showing a container lid 200 with a removable built-in RFID tag T, according to an embodiment of the present invention. FIG. 4 is an exploded perspective view of the container lid 200 with the removable built-in RFID tag T. FIG. 5 is a sectional view of the container lid 200 with the removable built-in RFID tag T. FIG. 6 is a sectional view showing a container lid 200 with a removable built-in RFID tag T, according to another embodiment of the present invention.

As shown in the drawings, the container lid 200 according to the present invention includes a main body 210, a tag mount 220, a tag holder 230 and a tag mount cover 240.

The main body 210 forms a main part of the container lid 200 in the same manner as that of typical container lids. The main body 210 has a flat cylindrical shape which is open on the lower end thereof and covers an open end of a container. As shown in FIG. 5, an internal thread 212 which corresponds to an external thread formed on the circumferential outer surface of the open end of the container is formed on the circumferential inner surface of the main body 210 such that the container lid 200 can be threaded over the open end of the container. This structure of the main body 210 is the same as that of the typical container lids, therefore further explanation is deemed unnecessary.

The tag mount 220 is provided on the upper surface of the main body 210. The tag mount 220 is a housing which has therein an installation space, in which the RFID tag T is installed. As shown in FIGS. 3 through 5, the tag mount 220 may be integrally formed with the main body 210 by injection molding in a shape such that the tag mount 220 protrudes from the upper surface of the main body 210. Alternatively, the tag mount 220 may be formed by injection molding as a separate component different from the main body 210 and then attached to the upper surface of the main body 210, for example, by adhesive. Meanwhile, as shown in FIG. 6, the tag mount 220 may be formed in such a way that a portion of the upper surface of the main body 210 is depressed and an installation space is formed in the depressed portion.

As shown in FIG. 5, the tag mount 220 includes a frame 222 which is open on the upper end thereof such that the RFID tag T is inserted downwards thereinto through the open upper end thereof. The frame 222 protrudes from the upper surface of the main body 210 to define therein the installation space having a predetermined size. A locking extension 224 extends inwards from the upper end of the frame 222. Thus, a holder mounting recess 226, into which the tag holder 230 (to be explained later) is inserted, is defined by the locking extension 224 along a lower portion of the inner sidewall of the frame 222.

The tag holder 230 is a means for holding stationary and supporting the RFID tag T in the tag mount 220 without its moving. As shown in FIG. 4, the tag holder 230 has an approximately ring shape which is open on one portion thereof. In detail, the inner surface of the tag holder 230 has a shape corresponding to that of the periphery of the RFID tag T so as to hold the outer surface of the RFID tag T to be installed. Opposite ends of the open portion of the tag holder 230 are bent inwards to prevent the RFID tag T from being removed from the tag holder 230 through the open portion of the tag holder 230.

Preferably, the tag holder 230 is made of soft elastic material such as elastic rubber in order to stably hold the RFID tag T. As such, in the case where the tag holder 230 is made of soft material having sufficient elasticity, when the RFID tag T is fitted into the tag holder 230, the tag holder 230 is temporarily elastically bent outwards and then returned to its original state by its own restoring force, thus compressing the periphery of the RFID tag T. Therefore, force with which the tag holder 230 holds the RFID tag T is increased, so that the tag holder 230 can reliably hold the RFID tag T stationary.

As stated above, the tag holder 230 is inserted into the holder mounting recess 226 which is formed at a lower position in the tag mount 220. In this structure, if the tag holder 230 is made of inelastic hard material, because the open upper end of the tag mount 220 is partially covered with the locking extension 224 and is thus smaller than the holder mounting recess 226, the tag holder 230 may not be able to be inserted into the holder mounting recess 226. However, in the present invention, the tag holder 230 is made of soft elastic material. Therefore, when the tag holder 230 is elastically bent inwards, inserted into the holder mounting recess 226 through the open upper end of the tag mount 220, and is released, the tag holder 230 spreads outwards, that is, it is returned to its original state by its own restoring force. Thereby, the tag holder 230 can be stably seated into the holder mounting recess 226. In the state in which the tag holder 230 is seated in the holder mounting recess 226, the periphery of the tag holder 230 is brought into close contact with the inner sidewall of the frame 222 of the tag mount 220, and the upper surface thereof is brought into close contact with the locking extension 224 of the tag mount 220. Therefore, the tag holder 230 can be stably mounted in the tag mount 220.

Furthermore, because the tag holder 230 is made of soft material, it has a shock absorption function. Therefore, there is an advantage in that the RFID tag T can be prevented from being damaged by external shock.

The RFID tag T is fitted into the tag holder 230 which has been mounted in the tag mount 220 by the above-mentioned method. The RFID tag T is inserted into the tag mount 220 through the open upper end of the tag mount 220 and is fitted into the tag holder 230. Thus, the RFID tag T can be stably held and supported by the tag holder 230 mounted in the tag mount 220.

The RFID tag T includes an IC chip which stores various kinds of information, such as ingredients, properties, quantity enclosed, the date of manufacture, the degree of hazardousness, etc., of contents contained in the container, and an antenna for performing radio communication with an external reader. The RFID tag T is covered with synthetic resin, such as PVC, for sealing it. In particular, a plastic card type tag such as a smart card is preferably used as the RFID tag T. As such, it is preferable that the RFID tag T be reliably sealed from the outside to prevent it from being contaminated by impurities, for example, liquids or the like. Furthermore, preferably the RFID tag T is of a predetermined thickness and shape appropriate to be reliably held and supported by the tag holder 230.

After the RFID tag T is fitted into the tag holder 230, the open upper end of the tag mount 220 is covered with the tag mount cover 240. The material of the tag mount cover 240 is not limited to any special material though it is preferably made of a transparent material which can cover the open upper end of the tag mount 220 and allow a user to observe the state of the RFID tag T installed in the tag mount 220, for example, as when the tag mount cover 240 is made of acryl or transparent plastic and is fitted into the open upper end of the tag mount 220. As a method of fitting the tag mount cover 240 into the open upper end of the tag mount 220, there may be various methods including a method using a hook structure. These methods can be easily implemented and modified by those skilled in the art and thus must be regarded as falling within the scope of the present invention.

Meanwhile, to prevent the RFID tag T from being permeated by impurities, such as moisture or liquid, which may affect the performance of the RFID tag T, it is preferable that the open upper end of the tag mount 220 form an airtight seal with the tag mount cover 240. For example, preferably, the tag mount cover 240 may be made of a transparent film and be adhered to the upper surface of the locking extension 224 of the tag mount 220 by adhesive or heat welding, thus airtightly sealing the open upper end of the tag mount 220.

In the present invention, the RFID tag T is installed in the container lid by the above-mentioned method. As necessary, the replacement of the RFID tag T installed in the container lid may be required. In this case, first, the tag mount cover 240 which has covered the open upper end of the tag mount 220 is removed from the tag mount 220. Thereafter, the tag holder 230 is elastically bent outwards and the RFID tag T is separated from the tag holder 230. Subsequently, a new RFID tag T is fitted into the tag holder 230. Here, if the size or shape of the existing RFID tag T differ from that of the new one, the tag holder 230 itself is removed from the tag mount 220 and then a new tag holder 230 corresponding to the size or shape of the new RFID tag T is installed in the tag mount 220 before the installation of the new RFID tag T. After the RFID tag T is replaced with a new one, the open upper end of the tag mount 220 is sealed again with the tag mount cover 240.

As such, when the RFID tag T is damaged or has had it, or when it is required to change in size or shape thereof, the RFID tag T or the tag holder 230 can be easily replaced with a new one.

As described above, in the present invention, the installation of an RFID tag in a container lid is simple, and the RFID tag can be prevented from malfunctioning or suffering damage attributable to external factors. Furthermore, when necessary, just the RFID tag itself can be conveniently replaced with a new one without requiring the replacement of the entire container lid, thus reducing resource consumption. In addition, continuity of content information management can be ensured.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A container lid with an RFID (radio frequency identification) tag, comprising:
a main body to cover an open end of a container;
a tag mount protruding from an upper surface of the main body, the tag mount being open on an upper end thereof and having therein an installation space into which the RFID tag is inserted through the open upper end of the tag mount;
a tag holder to hold and support the RFID tag in the tag mount; and
a tag mount cover to cover the open upper end of the tag mount.

2. The container lid as set forth in claim 1, wherein the RFID tag comprises a plastic card type tag, including: an IC chip to store various kinds of information about contents contained in the container; and an antenna for performing radio communication, wherein the plastic card type tag is covered and sealed with synthetic resin.

3. The container lid as set forth in claim 1, wherein the tag mount comprises:
a frame protruding from the upper surface of the main body such that the installation space is defined in the frame, with a locking extension extending inwards from an upper end of the frame such that a holder mounting recess is formed by the locking extension along a lower portion of an inner sidewall of the frame, so that the tag holder is inserted into the holder mounting recess.

4. The container lid as set forth in claim 1, wherein the tag holder has a ring shape which is open on one portion thereof to form an opening, wherein an inner surface of the tag holder has a shape corresponding to a shape of a periphery of the RFID tag so as to hold an outer surface of the RFID tag, and opposite ends of the open portion of the tag holder are bent inwards to prevent the RFID tag from being removed from the tag holder through the open portion of the tag holder.

5. The container lid as set forth in claim 1, wherein the tag holder is made of soft elastic synthetic resin.

6. The container lid as set forth in claim 1, wherein the tag mount cover is made of transparent material.

7. The container lid as set forth in claim 1, wherein the tag mount cover is made of a transparent film, and a perimeter of the tag mount cover is adhered to an upper surface of the tag mount by heat welding, thus sealing the open upper end of the tag mount.
